(19) United States
(12) Patent Application Publication
(10) Pub. No.: US 2022/0271939 A1
(43) Pub. Date: Aug. 25, 2022

(54) CONTROLLING POWER STATES AND OPERATION OF MOBILE COMPUTING DEVICES

(71) Applicant: Booz Allen Hamilton Inc., McLean, VA (US)

(72) Inventors: Gary Jason Myers, McLean, VA (US); Matthias Ackerly Welsh, McLean, VA (US)

(73) Assignee: Booz Allen Hamilton Inc., McLean, VA (US)

(21) Appl. No.: 17/679,301

(22) Filed: Feb. 24, 2022

Related U.S. Application Data
(60) Provisional application No. 63/153,873, filed on Feb. 25, 2021.

(51) Int. Cl. H04L 9/32; H04L 9/08

(52) U.S. Cl. CPC H04L 9/3231; H04L 9/3236; H04L 9/0819

(57) ABSTRACT

Techniques are disclosed for managing a device. The techniques include, in response to a policy check trigger, checking for a policy based on communications with one or more policy-granting devices; and permitting or denying access to the device based on the checking.

### CROSS-REFERENCE TO RELATED APPLICATIONS

This application claims priority to pending U.S. Provisional Patent Application Ser. No. 63/153,873, entitled “CONTROLLING POWER STATES AND OPERATION OF MOBILE COMPUTING DEVICES,” filed on Feb. 25, 2021, the entirety of which is hereby incorporated herein by reference.

### BACKGROUND

Controlling the permissions for use of computing devices is important in many areas of industry and government. Improvements in techniques for controlling such permissions are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of a system for managing operation of a device, according to an example;

FIG. 3 illustrates an example sequence of operations for managing the device according to a policy;

FIG. 4 is a block diagram that illustrates example operations performed by the device based on whether a policy was obtained and what is indicated in the policy if obtained; and

FIGS. 5 and 6 illustrate techniques for operating a device according to examples.

### DETAILED DESCRIPTION

Techniques are disclosed for managing a device. The techniques include, in response to a policy check trigger, checking for a policy based on communications with one or more policy-granting devices; and permitting or denying access to the device based on the checking.

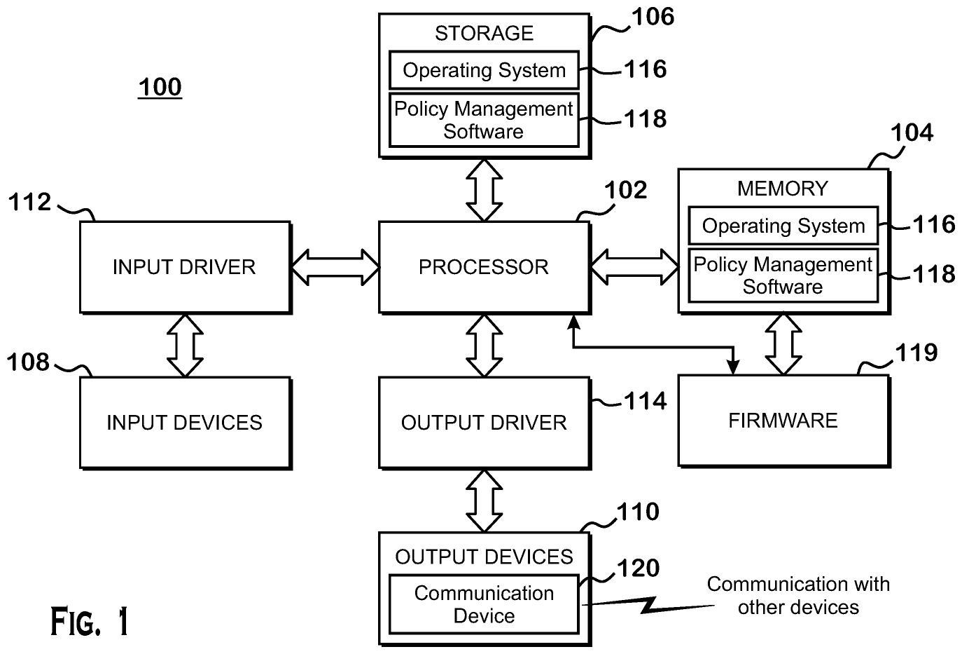

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 108 (e.g., controlling operation, receiving inputs from, and providing data to input drivers 112). Similarly, any of the output drivers 114 are embodied as hardware, a combination of hardware and software, or software, and serve the purpose of controlling output devices (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, without limitation, random access memory (RAM), dynamic RAM, or a cache. In some configurations, the memory 104 stores an operating system 116 and policy management software 118.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110.

In operation, the storage 106 and memory 104 store an operating system 116. The operating system 116 performs various tasks such as scheduling software for execution, managing hardware, and performing various tasks for user interaction. The firmware 119 performs operations such as loading the operating system 116 or a policy management software component 118, as discussed elsewhere herein. The output devices 110 include a communication device 120, which, in various examples, includes one or more of a wireless or wired communication device, one or more sensors, or one or more other devices for communicating with and/or receiving communications from one or more external devices.

The policy management software 118 manages one or more permissions policies and controls operation of the device 100 according to those permissions policies. The term “permissions policy” is sometimes replaced with the shortened term “policy” herein. As used herein, the term “permissions policy” or “policy” means an item of information that indicates whether and how the device 100 is permitted to be used. In various example policies, a policy indicates that the device 100 is permitted to be used with no restrictions, is permitted to be used with restrictions, or is not permitted to be used. The policy management software 118 controls access to the device according to a permissions policy.

In general, the policy management software 118 attempts to ensure that the device 100 is operating within an environment in which the device is “permitted” to operate in. In other words, the policy management software 118 communicates with one or more policy granting devices in the vicinity of the device 100 to obtain one or more policies. Each of the one or more policies indicates whether the device is permitted to operate (e.g., be powered on). If the policy management software 118 of the device 100 is unable to obtain a policy (for example, because the device 100 is not in the vicinity of a policy granting device or because a policy granting device refuses to provide a policy to the device 100) or if the policy obtained does not permit the device to be operated (e.g., the policy is invalid, expired, or corrupt), then the policy management software 118 does not permit the device 100 to be operated. If the policy management software 118 obtains a valid policy, and the policy indicates that the device is permitted to be operated, then the policy management software 118 allows the device to be operated. In some modes of operation, or in some examples, the device 100 caches received policies and can thus operate for a period of time without communication with the external devices. In other words, even where the policy management software 118 is unable to obtain a new policy from a policy granting device, the policy management software 118 continues to permit operation of the device according to an older, cached policy. However, once such a cached policy expires, the device 100 is no longer allowed to operate. In sum, the device 100 communicates with a policy granting system to determine whether the device 100 is allowed to be used. The policy granting system thus establishes a physical “perimeter” or “area” outside of which the device 100 cannot be used. The policy granting system thus controls where the device 100 can be used and allows for the device 100 to be disabled in the event that the device 100 is moved outside of a permitted area. Additional details follow.

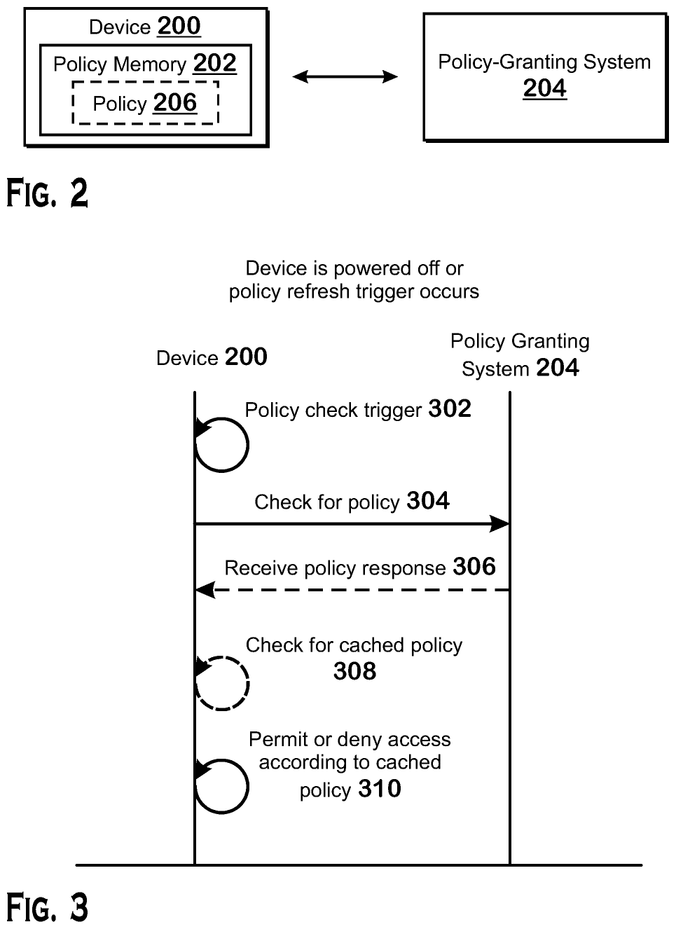

FIG. 2 is a block diagram of a system for managing operation of a device 200, according to an example. The device 200 is a computing device that executes software for a user. In various examples, the device 200 is a computer such as a laptop or desktop computer, a mobile device such as a phone or tablet, or another device with computing capabilities. In various examples, the device 200 is the device 100 of FIG. 1. Thus, the term “device 200” as used herein can be replaced with “device 100” herein, and the term “device 100” can be replaced with “device 200” herein.

The device 200 includes a policy memory 202 which is configured to store a policy 206. In various examples, the policy memory 202 is the memory 104 or is a different memory. In some examples, the policy memory 202 has security measures to prevent tampering with or reading the contents of the policy memory 202. The policy 206 in the policy memory 202 indicates whether the device 200 is permitted to be in a powered on state and, optionally, also indicates additional permissions that indicate ways in which the device 200 is permitted or not permitted to be used. In addition, the policy 206 also includes validity information that indicates whether the policy 206 is valid. In some examples, the validity information includes a cryptographic key. The policy management software 118 is able to determine whether the policy 206 is valid based on the validity information. It is possible for the policy 206 to be corrupted or maliciously tampered with. In such situations, the policy is considered not valid.

The policy-granting system 204 includes one or more objects or devices that grant a policy 206 to the device 200. Each of these one or more objects or devices is sometimes referred to herein as a “policy granting device.” The policy granting devices include one or more “active” devices that transmit a policy 206 to the device 200 and/or one or more “passive” devices that interact with the device 200 to cause the device 200 to update, grant, or refresh the policy 206. In various examples, the active components are components that are capable of transmitting information to the device 200, and the passive components are components that the device 200 detects with sensors. In examples, active components include other computing devices or electronic devices that emit electronic or other types of signals. In some examples, active components include one or more wireless local area network (“WLAN”) devices, one or more wired local area network (“LAN”) devices, one or more Bluetooth devices, one or more cellular devices, or other devices. In examples, passive components include, without limitation, graphical information detected with a camera (e.g., graphical elements on paper or graphical elements on a screen), biometric information, or other elements, objects, or device.

In some examples, the policy-granting system 204 grants the policy 206 by transmitting the policy 206 to the device. In some examples, the device 200 provides credentials, such as a cryptographic key, to the policy-granting system 204, which validates those credentials, and, if valid, provides a policy 206 associated with those credentials to the device 200. In some such examples, the part of the policy granting system 204 that communicates with the device 200 to provide the policy to the device 200 is an active device of the policy granting system 204. In other examples, the device 200 generates the policy 206 based on communication received from the policy-granting system 204. In some examples, the device 200 “refreshes” a policy 206 based on one or more signals received from the policy-granting system 204. In some examples, “refreshing” the policy includes extending the expiration time of the policy 206. In some such examples, the part of the policy granting system 204 that generates the signals is a passive device of the policy granting system 204. In such examples, the device 200 observes or detects the passive device and, in response to such detection, refreshes a policy that the device 200 already has.

As described, the policy granting system 204 grants the ability to use the device 200. The device 200—specifically, the policy management software 118—identifies conditions under which the device 200 is prohibited from being used. These conditions include, for example, that the policy 206 obtained via the policy-granting system 204 does not allow use of the device 200 (e.g., due to the policy specifically prohibiting use, being expired, or being otherwise invalid), as well as the device 200 being unable to obtain a policy 206, or a policy 206 being expired. In any such case, the policy management software 118 powers the device down. In addition, in some cases, after a wipe timer has expired, the policy management software 118 wipes the device. Wiping the device means clearing one or more memories of the device, such as a hard drive and/or a trusted memory that stores cryptographic keys. A wipe timer measures the amount of time since policy expiration has occurred. The “wipe timer” should be understood as any mechanism for counting time or actions, and can include a timer that measures time, a counter that measures time or events that act as time proxies, a clock, or any other logical mechanism capable of measure a duration of time or counting a number of events.

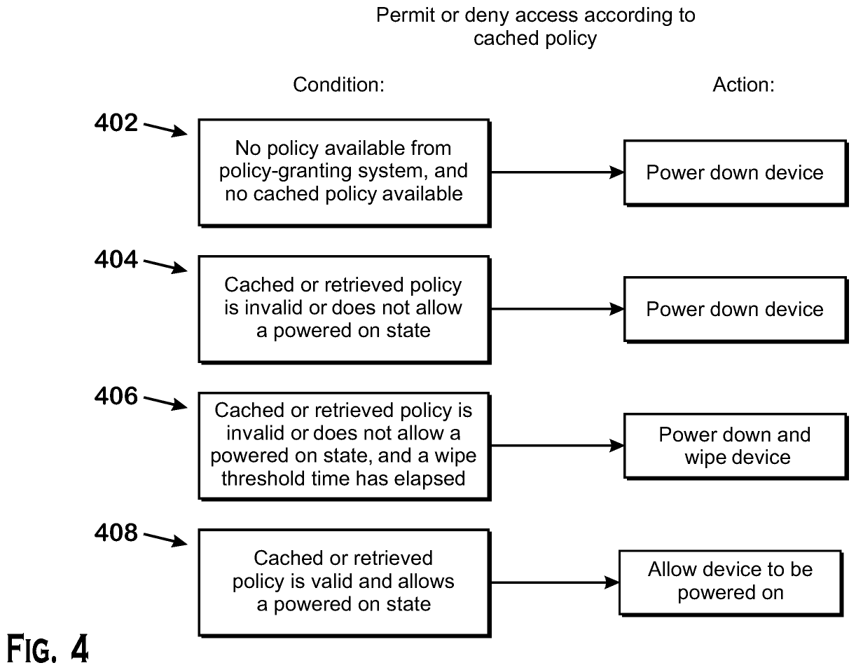

FIG. 3 illustrates an example sequence of operations for managing the device 200 according to a policy 206. At operation 302, the device 200 detects a policy check trigger. In some examples, the policy check trigger is the device 200 being powered on. In this example, detecting the policy check trigger includes detecting that the device 200 has been powered on. In other examples, the policy check trigger is part of a heartbeat operation in which the device detects that a period of time has elapsed from the last policy check trigger. In other words, a heartbeat operation is an operation in which the device 200 periodically checks whether a policy 206 grants use of the device 200. In this example, detecting the policy check trigger includes detecting that a certain amount of time has passed since previously checking whether the policy 206 grants use of the device 200.

At operation 304, in response to the policy check trigger, the device 200 checks whether a new policy should be created or whether a policy should be refreshed based on communication with the policy granting system 204. More specifically, as described elsewhere herein, the device 200 attempts to either communicate with an active device of the policy granting system 204 or to detect presence of a passive device of the policy granting system 204.

At operation 306, the device 200 receives or does not receive a response from the policy granting system 204. In situations where the device 200 detects presence of a passive device of the policy granting system 204, or in situations where the device 200 is able to communicate with an active device of the policy granting system 204, the device 200 is considered to have received a response from the policy granting system 204. In situations where the device 200 does not detect presence of a passive device of the policy granting system 204, or in situations where the device 200 is unable to communicate with an active device of the policy granting system 204, the device 200 is considered to have not received a response from the policy granting system 204.

In the situation that communication with the policy granting system 204 indicates that no policy should be granted or that a policy stored in the device 200 should not be refreshed, or in the situation that the device 200 is unable to communicate with one or more components of the policy granting system 204, the device performs operation 308.

Some examples of the operations 304 and 306 are now provided. In one example, the device 200 detects presence of a passive device of the policy granting system 204 and determines that presence of the passive device indicates that a policy stored in the device 200 should be refreshed. In some examples, the device 200 stores information that indicates which passive devices indicate that a policy should be refreshed. In another example, the device 200 communicates with an active device of the policy granting system 204. The communication includes requesting a new policy or requesting permission to refresh a policy already stored in the device 200. In response, the active device of the policy granting system 204 responds by providing a policy to the device 200 or by indicating to the device 200 that the device is permitted to refresh a policy stored in the device. In yet another example, the device 200 communicates with an active device of the policy granting system to attempt to obtain a policy or to attempt to obtain permission to refresh a policy in the device 200, but the active device refuses to provide such a policy or permission to the device 200. In yet another example, the device 200 is unable to communicate with an active device or passive device, for example, due to being out of communication range with any active device or passive device.

At operation 308, having not been able to receive a policy based on communication with the policy granting system 204, the device checks for a cached policy 206 stored in the policy memory 202. At operation 310, the device 200 permits or denies access to the device 200 based on the policy 206. In the situation that the policy is valid and not expired, the device 200 permits access to the device 200 as specified by the policy 206. In the situation that no policy is stored in the device 200, that the policy is invalid or expired, or that the policy indicates that the device is not allowed to be used, the device 200 denies access to the device 200.

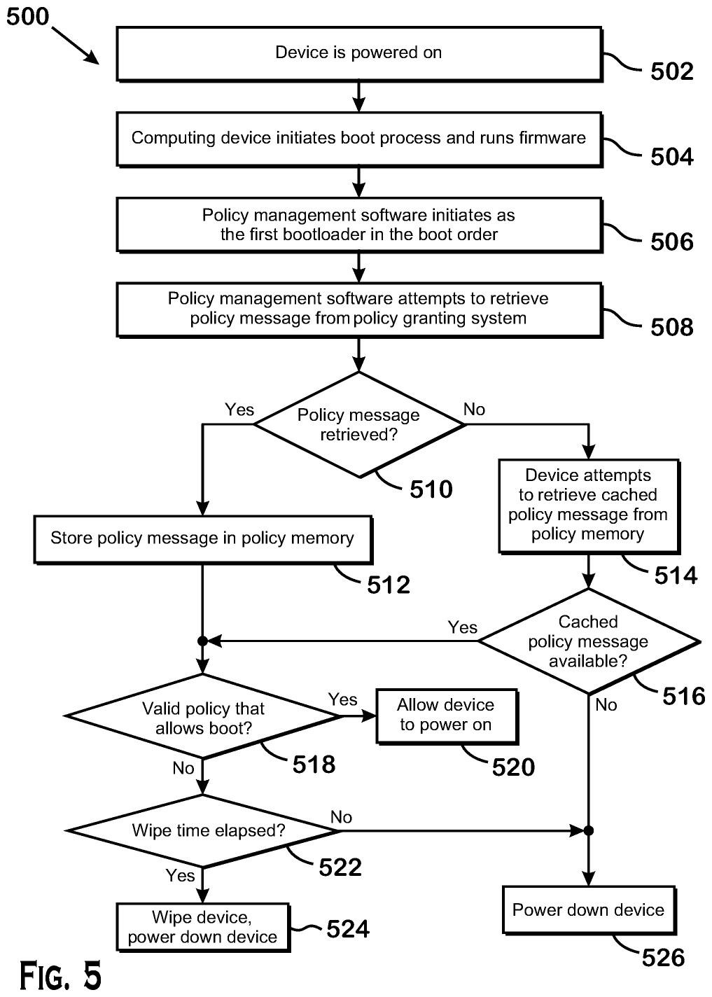

FIG. 4 is a block diagram that illustrates example operations performed by the device 200 based on whether a policy 206 was obtained and what is indicated in the policy if obtained. FIG. 4 represents possible actions to take for operation 310 of FIG. 3. That is, FIG. 4 represents operations associated with granting or denying access to the device 200 according to the policy 206. According to condition 402, on the condition that the device 200 is unable to obtain a policy based on communication with the policy granting system 204, and on the condition that there is no cached policy 206, the device 200 powers down 200.

According to condition 404, the device 200 is able to obtain a policy, either based on communication with policy granting system 204 or based on a cached policy 206. In this situation, if the obtained policy 206 is invalid or does not allow a powered-on state, then the device 200 powers down.

According to condition 406, the obtained policy 206 is invalid or does not allow a powered-on state, and a wipe threshold time has elapsed. In this condition, the device 200 erases (“wipes”) data in storage. In some examples, wiping data in storage includes erasing some or all data in a hard drive of the device 200. In some examples, wiping data alternatively or additionally includes erasing one or more credentials, such as cryptographic keys, communication credentials, and authentication certificates. In various examples, some or all of these credentials are stored within a protected memory that has enhanced security features to protect against tampering, as compared with the hard drive or other storage on which other software such as the operating system and applications are stored.

According to condition 408, the obtained policy 206 is valid. In this condition, the device 200 remains powered on or allows booting.

Regarding the operations of FIGS. 3 and 4, in some situations, these operations are performed in response to powering on the device 200. In other words, in some situations, the policy check trigger 302 is the device 200 being powered on. In some examples, in these situations, the action taken (right-hand column of FIG. 4) is taken by the policy management software 118 executing as software loaded by a bootloader before the operating system 116. In an example, the boot sector of a hard drive of the device 200 is configured to load the policy management software 118 before the operating system 116. The policy management software 118 performs the operations of FIGS. 3 and 4.

In other situations, the operations of FIGS. 3 and 4 are performed in response to a trigger while the device 200 is already executing the operating system 116. In other words, the policy management software 118 that performs the operations of FIGS. 3 and 4 is software that executes in the context of an operating system 116. In some such examples, such policy management software 118 periodically performs the operations of FIGS. 3 and 4, for example, as part of a heartbeat mechanism.

In some examples, the device 200 includes both a version of the policy management software 118 that executes prior to the operating system 116 and in response to powering on the device 200, as well as a version of the policy management software 118 that executes in the context of the operating system 116. Thus, the device 200 would be able to check the policy 206 and perform appropriate actions as specified herein (i.e., in FIGS. 3 and 4) both in response to the device 200 being powered on and while the device 200 is already operating.

In some examples, in the case that the policy management software 118 is executing in the context of the operating system 116 and the policy management software 118 determines that a wipe is to occur for the device, the policy management software 118 performs the wipe in the following manner. The policy management software 118 executing in the context of the operating system 116 causes the device 200 to restart and to load the bootloader version of the policy management software 118 (that is, the software that is executed by the boot loader before executing the operating system. The policy management software 118 executing in this manner then causes the credentials to be deleted and the hard drive to be erased.

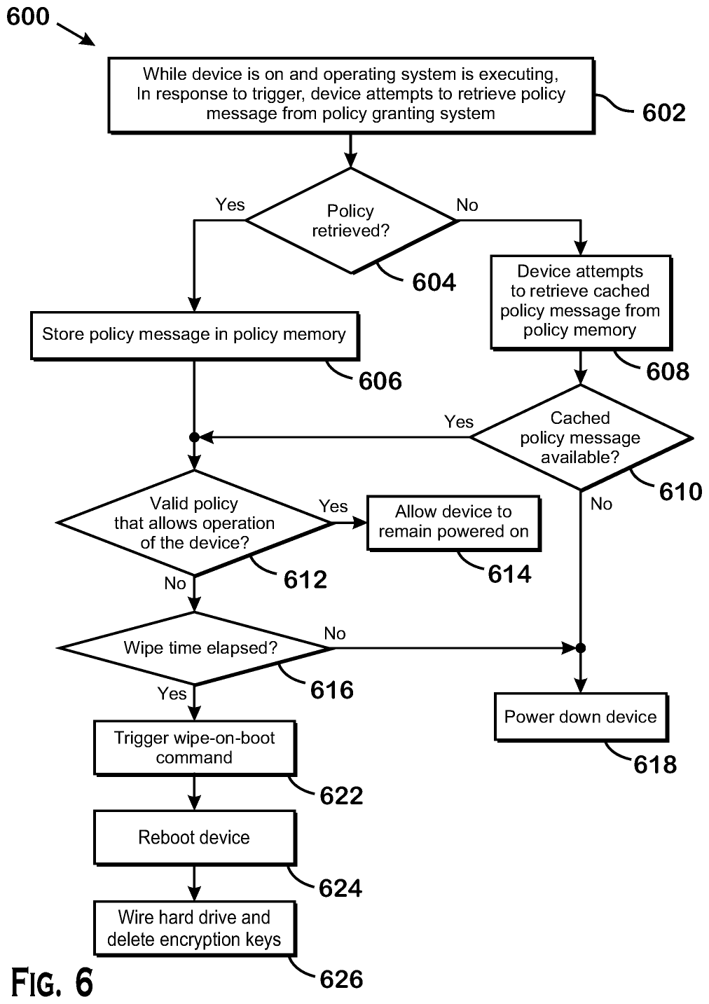

FIGS. 5 and 6 illustrate techniques for operating a device 200 according to examples. FIG. 5 illustrates a technique in which the device 200 begins in a powered-down state and is switched on (or “powered on”) and FIG. 6 illustrates a technique in which the device 200 begins in a powered-on state, already executing the operating system. Although the methods of FIGS. 5 and 6 are described with respect to the system of FIGS. 1-4, those of skill in the art will understand that any system, configured to perform the steps of methods 500 or 600 in any technically feasible order, falls within the scope of the present disclosure.

Regarding FIG. 5, at step 502, the device 200 is powered on. At step 504, the device 200 initiates a boot process and runs firmware 119. In examples, the firmware is a basic input/output system (“BIOS”) or a unified extensible firmware interface (“UEFI”). At step 506, the firmware initiates a bootloader, which initiates the policy management software 118 before loading an operating system 116.

At step 508, the policy management software 118 attempts to retrieve a policy message from the policy-granting system 204 as described elsewhere herein (for example, with respect to FIGS. 3 and 4). At step 510, the policy management software 118 determines whether a policy is retrieved from the policy-granting system 204. If a policy is retrieved, then the method 500 proceeds to step 512 and if a policy is not retrieved, then the method 500 proceeds to step 514. At step 512, the policy management software 118 stores the policy in the policy memory 202 and the method 500 proceeds to step 518.

At step 514, the policy management software 118 attempts to retrieve a cached policy from the policy memory 202. At step 516, the policy management software determines if a cached policy is available. If the cached policy is available, then the method 500 proceeds to step 518. If the cached policy is not available, then the method 500 proceeds to step 526.

At step 518, the policy management software 118 determines whether the policy 206 is valid and allows the device 200 to be powered on. If the policy 206 is not valid or does not allow the device 200 to be powered on, then the method 500 proceeds to step 522. If the policy 206 is valid and allows the device 200 to be powered on, then the method proceeds to step 520, where the device 200 powers on (e.g., allowing the operating system 116 to boot up).

At step 522, the policy management software 118 determines whether a wipe timer has elapsed. In an example, the wipe timer measures an amount of time from when the policy 206 has expired. If this amount of time is over a wipe timer threshold that is known to the policy management software 118, then the method 500 proceeds to step 524 and if the amount of time is not over the wipe timer threshold, then the method proceeds to step 526. At step 524, the policy management software 118 wipes the device (including one or both of some or all of the hard drive contents and some or all of a trusted memory that stores one or more credentials). One of the ways in which the policy 206 can be invalid is that the policy has expired. The policy typically indicates an amount of time that the policy is valid for. If this amount of time has elapsed, then the policy is expired. If the policy 206 is expired, then the policy management software 118 does not allow the device 200 to boot up. If the policy 206 is invalid for an additional amount of time indicated by the wipe threshold, then in addition, the policy management software 118 wipes the device 200.

At step 526, having determined that either the policy is valid but the wipe timer has not elapsed, or that no policy is available, the policy management software 118 powers down the device 200 instead of letting the device 200 boot into the operating system 116.

As stated above, the method 600 of FIG. 6 represents a method that occurs when the device 200 is already powered on and is, for example, executing the operating system 116. At step 602, the policy management software 118, in response to a policy check trigger (such as a timer indicating that an amount of time greater than a threshold time has passed), the device 200 attempts to retrieve a policy message from the policy granting system 204. At step 604, the policy management software 118 determines whether the policy is retrieved. If the policy 206 is not retrieved, then the method 600 proceeds to step 608 and if the policy 206 is retrieved, then the method 600 proceeds to step 606. At step 606, the policy management software 118 stores the policy 206 in the policy memory 202.

At step 608, the policy management software 118 attempts to retrieve a cached policy 206 from the policy memory 202. At step 610, the policy management software 118 determines if there is a cached policy 206 available. If there is a cached policy available, then the method 600 proceeds to step 612 and if there is no cached policy available, then the method 600 proceeds to step 618.

At step 612, the policy management software 118 determines whether the policy 206 is a valid policy that allows the device 200 to remain powered on. If the policy 206 is a valid policy and allows the device 200 to remain powered on, then the method 600 proceeds to step 614, where the policy management software 118 allows the device 200 to remain powered on. If the policy 206 is not a valid policy that allows the device 200 to remain powered on, then the method proceeds to step 616.

At step 616, if the wipe time has elapsed, then the method 600 proceeds to step 622, and if the wipe-time has not elapsed, then the method 600 proceeds to step 618, where the policy management software 118 powers down the device 200.

At step 622, the policy management software 118 triggers a wipe-on-boot command. The wipe-on-boot command causes the device 200 to reboot (step 624) and to load the policy management software 118 without loading the operating system. Due to the wipe-on-boot command, the policy management software 118 wipes the hard drive and deletes the credentials.

The term “cached policy” means a policy 206 previously retrieved from the policy granting system 204 and stored in the policy memory 202.

In the present disclosure, the terms “powering on” or “powering down” are sometimes used. In some examples, “powering on” means that the device 200 is allowed to boot into the operating system and operate normally, or that the device 200 is current switched on and is executing software such as the operating system. In some examples, “powering down” includes shutting the device down, such as would happen where a physical power switch is pressed or the operating system is requested to shut down the computing device.

It should be understood that many variations are possible based on the disclosure herein. For example, in some implementations, the policy granting system 204 includes multiple wireless communication devices. The device 200 communicates with these wireless communication devices to identify a distance from each such device. Based on this distance information, the device 200 or policy-granting system 204 performs triangulation to determine a location of the device 200. The device 200 or policy-granting system 204 checks whether that location is within an allowed area. If the location is within an allowed area, and all other requirements are met (e.g., the device 200 provides suitable credentials to the policy-granting system 204) then the device 200 permits use by a user. If the location is not within an allowed area, then the device 200 does not permit use by a user, regardless of whether any of the other requirements are met. The wireless communication devices can be any technically feasible wireless communication device, such as wi-fi or any other wireless communication device. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a graphics processor, a machine learning processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for managing a device, the method comprising:
in response to a policy check trigger, checking for a policy based on communications with one or more policy-granting devices; and
permitting or denying access to the device based on the checking.

2. The method of claim 1, wherein the policy check trigger comprises the device being powered on and a boot process occurring.

3. The method of claim 1, wherein the policy check trigger comprises detecting a heartbeat.

4. The method of claim 1, wherein the checking includes:
in response to determining that no policy-granting device grants a valid policy, checking for a policy cached within the device.

5. The method of claim 1, wherein the checking includes determining that a policy obtained based on the communications with the one or more policy-granting devices or a cached policy is valid and not expired and indicates that the device is usable by a user; and
permitting or denying access to the device based on the checking comprises permitting the device to boot or to remain powered on.

6. The method of claim 1, further comprising:
in response to determining that a wipe timer has elapsed, wiping one or more of a hard drive of the device and a trusted memory that stores cryptographic keys of the device.

7. The method of claim 6, wherein wiping the hard drive includes rebooting the device, executing a policy management software without executing an operating system, and wiping the hard drive.

8. The method of claim 6, further comprising:
in response to determining that the wipe timer has elapsed, deleting one or more of communication credentials, cryptographic keys, and authentication certificates.

9. The method of claim 1, wherein the checking includes determining that no policy is obtained based on the communications with the one or more policy-granting devices, and that no policy is cached; and
permitting or denying access to the device based on the checking comprises causing the device to be powered down.

10. A device, comprising:
a processor; and
a memory that has instructions that when executed by the processor, cause the processor to:
in response to a policy check trigger, check for a policy based on communications with one or more policy-granting devices; and
permit or deny access to the device based on the checking.

11. The device of claim 10, wherein the policy check trigger comprises the device being powered on and a boot process occurring.

12. The device of claim 10, wherein the policy check trigger comprises detecting a heartbeat.

13. The device of claim 10, wherein the checking includes:
in response to determining that no policy-granting device grants a valid policy, checking for a policy cached within the device.

14. The device of claim 10, wherein the checking includes determining that a policy obtained based on the communications with the one or more policy-granting devices or a cached policy is valid and not expired and indicates that the device is usable by a user; and
permitting or denying access to the device based on the checking comprises permitting the device to boot or to remain powered on.

15. The device of claim 10, wherein the instructions further cause the processor to:
in response to determining that a wipe timer has elapsed, wipe one or more of a hard drive of the device and a trusted memory that stores cryptographic keys of the device.

16. The device of claim 15, wherein wiping the hard drive includes rebooting the device, executing a policy management software without executing an operating system, and wiping the hard drive.

17. The device of claim 15, wherein the instructions further cause the processor to:
in response to determining that the wipe timer has elapsed, delete one or more of communication credentials, cryptographic keys, and authentication certificates.

18. The device of claim 10, wherein the checking includes determining that no policy is obtained based on the communications with the one or more policy-granting devices, and that no policy is cached; and
permitting or denying access to the device based on the checking comprises causing the device to be powered down.

19. A non-transitory computer-readable medium that stores instructions that, when executed by a processor, cause the processor to manage a device, by:
in response to a policy check trigger, checking for a policy based on communications with one or more policy-granting devices; and
permitting or denying access to the device based on the checking.

20. The non-transitory computer-readable medium of claim 19, wherein the policy check trigger comprises the device being powered on and a boot process occurring.

21. The non-transitory computer-readable medium of claim 19, wherein the policy check trigger comprises detecting a heartbeat.

22. The non-transitory computer-readable medium of claim 19, wherein the checking includes:
in response to determining that no policy-granting device grants a valid policy, checking for a policy cached within the device.

23. The non-transitory computer-readable medium of claim 19, wherein the checking includes determining that a policy obtained based on the communications with the one or more policy-granting devices or a cached policy is valid and not expired and indicates that the device is usable by a user; and
permitting or denying access to the device based on the checking comprises permitting the device to boot or to remain powered on.

24. The non-transitory computer-readable medium of claim 19, wherein the instructions further cause the processor to:
in response to determining that a wipe timer has elapsed, wipe one or more of a hard drive of the device and a trusted memory that stores cryptographic keys of the device.

25. The non-transitory computer-readable medium of claim 24, wherein wiping the hard drive includes rebooting the device, executing a policy management software without executing an operating system, and wiping the hard drive.

26. The non-transitory computer-readable medium of claim 24, wherein the instructions further cause the processor to:
in response to determining that the wipe timer has elapsed, delete one or more of communication credentials, cryptographic keys, and authentication certificates.

27. The non-transitory computer-readable medium of claim 19, wherein the checking includes determining that no policy is obtained based on the communications with the one or more policy-granting devices, and that no policy is cached; and
permitting or denying access to the device based on the checking comprises causing the device to be powered down.
